(19) United States
(12) Patent Application Publication
(10) Pub. No.: US 2009/0220785 A1
(43) Pub. Date: Sep. 3, 2009

(54) METHOD AND DEVICE FOR FORMING MICROSTRUCTURED FIBRE

(75) Inventors: Tanya Monro, South Australia (AU); Heike Ebendorff-Heidepriem, South Australia (AU); Philip Davies, South Australia (AU)

Correspondence Address: GREENBLUM & BERNSTEIN, P.L.C., 1950 ROLAND CLARKE PLACE, RESTON, VA, 20191, US

(73) Assignee: ADELAIDE RESEARCH & INNOVATION PTY LTD, South Australia (AU)

(21) Appl. No.: 12/090,011

(22) PCT Filed: Oct. 12, 2006
(86) PCT No.: PCT/AU2006/001500

§ 371 Date: Jul. 2, 2008

(30) Foreign Application Priority Data
Oct. 12, 2005 (AU) 2005905619
Oct. 12, 2005 (AU) 2005905620

(51) Int. Cl. D02G 3/22; B29C 47/30; C03B 37/02

(52) U.S. Cl. 428/397; 425/114; 264/177.1; 264/176.1; 264/177.16

(57) ABSTRACT

A die and method for extruding an extrudable material to form an extruded member is described. In one embodiment, the die comprises a barrier member comprising a plurality of feed channels that extend through the barrier member. Furthermore, the die incorporates a passage forming member extending from the barrier member substantially in the direction of extrusion. The feed channels are arranged with respect to the passage forming member to allow the extrudable material to substantially flow about the passage forming member to form a corresponding passage in the extruded member.

### FIELD OF THE INVENTION

The present invention relates to the fabrication of optical fibres. In a particular form the present invention relates to forming a microstructured optical fibre having a complex transverse structure.

### PRIORITY

This application claim priority from the following Australian Provisional Patent Applications:

2005905619 entitled “Fabrication of Nanowires” filed on 12 Oct. 2005; and
2005905620 entitled “Method and Device for Forming Microstructured Fibre” filed on 12 Oct. 2005.

The entire content of each of these applications is hereby incorporated by reference.

### BACKGROUND OF THE INVENTION

Fibres having complex transverse structure in the form of a plurality of air channels extending longitudinally along the fibre, which are known in the art as microstructured optical fibres, have a number of desirable qualities when compared to conventional doped fibre implementations. They offer a number of unique optical properties and design flexibility that cannot be achieved with conventional fibres. Some of these properties include the ability to have light guidance in an air core via the photonic bandgap effect, broadband single mode guidance, anomalous dispersion down to 560 nm, large normal dispersion at 1550 nm and high form birefringence. In addition, by scaling the size of the features in the fibre profile, microstructured fibres can have mode areas and thus effective nonlinearity ranging over three orders of magnitude. Typically, microstructured fibres exhibiting this complex transverse microstructure have been formed by first constructing or fabricating a preform having macroscopic transverse features of dimensions in the order of millimetres. This preform is then subsequently drawn into a fibre on a drawing tower in one or several steps, thereby resulting in micron or sub-micron features in the resultant fibre. Construction or fabrication of the preform can be accomplished by a number of techniques. For preforms formed from silica or ‘hard’ glass, one technique involves stacking a number of circular cross sectioned capillaries and rods together inside a jacket in a hexagonal close packed configuration which is then drawn or ‘caned’ to form a cane which is then further drawn to form the fibre.

Clearly, this process requires a great deal of skill to arrange and stack the capillaries and rods, making this process extremely difficult to automate. Also this process is limited, to close packed transverse structures such as hexagonal or square formats which severely restricts the freedom of transverse arrangements that may be realised utilising this stacking method. Another disadvantage is that the large degree of handling required to stack the capillaries and rods can degrade their surfaces leading to significant losses in the resultant fibre. Additionally, this process does not lend itself to the use of ‘soft’ glasses which are being increasingly employed in applications due to their extended transmissive properties which reach into the infra-red and also their enhanced optical nonlinearity which can be two orders of magnitude higher than silica.

Whereas the stacking process described above first involves sourcing uniform tubes and rods having outer diameters in the range of 10-20 mm, which are then drawn down to the stacking elements (i.e. capillaries and rods) having outer diameters in the range 0.5-2.0 mm, these initial large scale uniform tubes and rods are not commercially available for the vast majority of soft glasses. Accordingly, elements must be produced individually which involves additional steps of glass melting and processing. Furthermore, soft glasses are usually melted in smaller quantities and thus the fabrication of large uniform tubes and rods is not a trivial exercise.

Another disadvantage in applying the stacking process to soft glasses is that the handling of the small-size stacking elements (capillaries and rods) is challenging for soft glass due to the higher fragility and their inherent scratchability when compared to silica. As uniform and highly regular stacks are desirable, long capillaries having uniform inner and outer diameter are crucial. However, the steep temperature-viscosity-curves and higher surface tensions of soft glasses make the fabrication of such capillaries having these uniform properties very difficult.

Another process used to fabricate preforms having a complex transverse microstructure is by the use of casting or moulding methods. These methods include glass casting, sol-gel casting, extrusion moulding of polymer melt and in-situ polymerisation of a monomeric material in a mould. These processes are generally based on either gravity or extrusion filling of a mould with a liquid and then solidifying this liquid such that it retains its moulded shape following removal the mould. In this process, the mould geometry will determine the preform structure.

In sol-gel casting methods this solidification stage involves gel formation by lowering the pH value of the sol introduced into the mould. For glass casting and polymer melts this solidification stage involves the cooling of the original liquid which results in solidification. In the case of in-situ polymerisation of a monomeric material, this solidification process involves the heating or curing of the monomeric material to facilitate the in-mould polymerisation process and subsequent cooling thereby resulting in a solid polymer result.

As with the stacking method discussed previously, the casting and moulding processes are also limited to a range of materials that are suitable for these processes such as glass melts having very low viscosity, those polymers suitable for polymer melts and sols containing colloidal particles such as silica. In addition, these processes require a large degree of manual intervention thereby making them difficult to automate. Another significant disadvantage of casting or moulding methods is that the preform is solidified within the mould which can result in surface contamination and enhanced surface roughness.

An attempt to address some of these problems and reduce the complexity of the process involved in fabricating a preform is to employ the forced flow of extrudable material such as a suitable polymer material or soft glass through an extrusion die into free-space to fabricate the preform. One such example is described in PCT Publication No. WO 03/078339 entitled “Fabrication of Microstructured Optical Fibre” which discloses an extruder die for forming a preform for manufacture into an optical fibre comprising a central feed channel for receiving a material supply by pressure-induced fluid flow; flow diversion channels arranged to divert a first component of the material radially outwards into a welding chamber formed within the die; a core forming conduit arranged to receive a second component of the material from the central feed channel that has continued its onward flow; and a nozzle having an outer part in flow communication with the welding chamber and an inner part in flow communication with the core forming conduit, to respectively define an outer wall and core of the preform.

The extruder die described above is indicative of the extremely complex die geometries that are required to form a preform for a microstructured fibre which in this case has a relatively simple hole arrangement. The die geometry is arrived at by either employing empirical means, thereby requiring a large amount of testing and trialling of die designs, or by complicated modelling of the interaction between the extruded material and the die geometry in the extrusion process. Accordingly, for each transverse structure design there is a large associated effort in determining the related die geometry that results in the desired transverse structure in the final fibre product.

It is an object of the present invention to provide a method and device capable of extruding an optical fibre preform that simplifies the design and fabrication of the die geometry for a desired fibre preform structure.

It is a further object of the present invention to provide a method and device capable of extruding an optical fibre preform which will allow automation of the extrusion process.

### SUMMARY OF THE INVENTION

In a first aspect the present invention accordingly provides a die for extruding an extrudable material to form an extruded member, the die comprising:
a barrier member, the barrier member comprising a plurality of feed channels extending through the barrier member;
a passage forming member extending from the barrier member substantially in the direction of extrusion, wherein the feed channels are arranged with respect to the passage forming member to allow the extrudable material to substantially flow about the passage forming member to form a corresponding passage in the extruded member.

By providing for homogenous flow through the barrier member via the plurality of channels and then about the passage forming member, any distortion introduced into the formation of the corresponding passage in the extruded member is substantially minimised. In addition, the arrangement of the feed channels with respect to the passage forming member ensures that the extrudable material is not required to substantially flow around edges or sharp bends which further minimises distortion of the corresponding passage in the extruded member. In this manner, the relationship between the passage forming member and the corresponding passage in the extruded member may be determined more readily when compared to prior art methods. Another important advantage of the present invention is that the geometry of the relationship of the passage forming member and the feed channels is inherently scalable.

Preferably, the die comprises a plurality of passage forming members extending from the barrier member substantially in the direction of extrusion and wherein the feed channels are arranged with respect to the plurality of passage forming members to allow the extrudable material to substantially flow about the passage forming members to form corresponding passages in the extruded member.

Preferably, at least one of the plurality of passage forming members comprise removable attachment means to removably attach the at least one passage forming member from the barrier means.

This provides an increased flexibility in designing the transverse structure of the extruded member as passage forming members may be added or removed from the die as required resulting in the adding or removal of corresponding structures in the extruded member.

Preferably, the passage forming members vary in size to form corresponding passages in the extruded member of varying size.

Preferably, the feed channels are of varying size to vary the amount of extrusion of said extrudable material.

Preferably, the feed channels and the passage forming members are arranged in a regular lattice.

Preferably, the die comprises an inlet chamber and an extrudate forming chamber and wherein the barrier member forms a feed hole plate located between the inlet chamber and the extrudate forming chamber.

Preferably, the feed hole plate is removable from the die.

Preferably, the extruded member is a microstructured fibre preform.

In a second aspect the present invention accordingly provides a method for extruding an extrudable material to form an extruded member, the method comprising the steps of:
forcing extrudable material through a plurality of feed channels extending through a barrier member and located about a passage forming member extending from the barrier member in the direction of extrusion; and
forming a passage in the extruded member by allowing the extrudable material to flow about the passage forming member.

In a third aspect the present invention accordingly provides an extruded member extruded according to the method of the second aspect of the present invention.

In a fourth aspect the present invention accordingly provides a method for extruding an extrudable material to form an extruded member, the method comprising the steps of:
heating a billet of material in an inlet chamber to a predetermined temperature to form extrudable material;
forcing the extrudable material from the inlet chamber through a barrier member into an extrudate forming chamber, wherein the barrier member comprises a feed hole plate having a plurality of feed channels and at least one passage forming member extending from the feed hole plate in a direction of extrusion, thereby forming at least one corresponding passage in the extruded member.

In a fifth aspect the present invention accordingly provides a method for configuring a die, the die for extruding an extrudable material to form an extruded member, the method comprising:
attaching at least one removably attachable passage forming member to a barrier member, the barrier member located between an inlet chamber and an extrudate forming chamber of the die, the barrier member further comprising a plurality of feed channels extending through the barrier member through which in use the extrudable material flows through, wherein a location of the at least one removably attachable passage forming member corresponds to a passage formed in the extruded member.

In a sixth aspect the present invention accordingly provides an extrusion machine comprising:
a receptacle for receiving a billet of material;
heating means to heat the billet of material to form an extrudable material;
a die receiving chamber to receive a die in accordance with a first aspect of the present invention;
forcing means to force the extrudable material through the die to form an extruded member; and
an output chamber for receiving the extruded member.

### BRIEF DESCRIPTION OF THE DRAWINGS

Embodiment of the present invention will be discussed with reference to the accompanying drawings wherein:

FIG. 1 is a side sectional view of a die for extruding an extrudable material according to a first embodiment of the present invention;

FIG. 2 shows perspective views depicting the rear or inlet end of the die collar component and a front view of the sieve or feed hole plate component which together form the die illustrated in FIG. 1.

FIG. 3 is a rear perspective view of the die components illustrated in FIG. 2 as assembled;

FIG. 4a is an end view of the feed hole plate illustrated in FIG. 3;

FIG. 4b is an end view of a fibre preform extruded from the feed hole plate illustrated in FIG. 4b;

FIG. 5a is an end view of a feed hole plate incorporating 7 rings of pins according to a second embodiment of the present invention;

FIG. 5b is an end view of a fibre preform extruded from the feed hole plate illustrated in FIG. 5a;

FIG. 6a is an end view of a feed hole plate incorporating 4 rings of pins and varying feed channel size according to a third embodiment of the present invention;

FIG. 6b is an end view of a fibre preform extruded from the feed hole plate illustrated in FIG. 6a;

FIG. 7a is an end view of a feed hole plate incorporating multiple cores according to a fourth embodiment of the present invention;

FIG. 7b is an end view of a fibre preform extruded from the feed hole plate illustrated in FIG. 7a;

FIG. 8 is an end view of a fibre preform having a central longitudinal portion supported by four equally space walls;

FIG. 9 is a rear end view of a die for extruding the fibre preform having the geometry illustrated in FIG. 8 according to a fifth embodiment of the present invention;

FIG. 10 is a side sectional view of the die illustrated in FIG. 9;

FIG. 11 is a rear end view of a die for extruding the fibre preform having the geometry illustrated in FIG. 8 according to a sixth embodiment of the present invention; and

FIG. 12 is a side sectional view of the die illustrated in FIG. 11.

In the following description, like reference characters designate like or corresponding parts throughout the several views of the drawings.

### DESCRIPTION

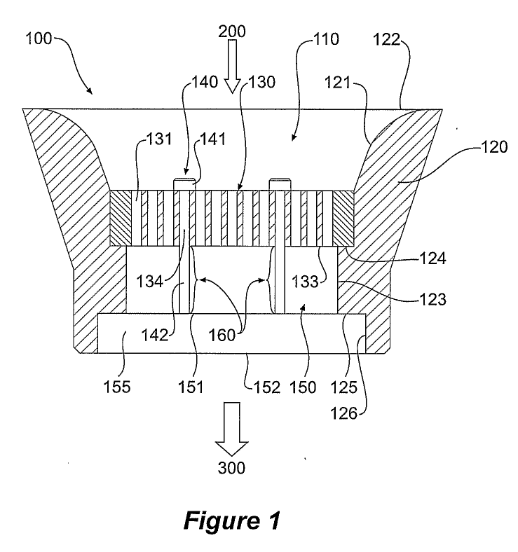

Referring now to FIG. 1, there is shown a side sectional view of a die 100 for extruding an extrudable material in the direction indicated by arrow 200 to form an extruded member as indicated generally by arrow 300 according to a first embodiment of the present invention. In this first embodiment, die 100 is for the fabrication of an optical fibre preform from a billet of polymer such as polymethylmethacrylate or alternatively a soft glass material selected from one of the classes of fluoride, chalcogenide or heavy metal oxide glasses. Additionally, combination billets may also be formed by stacking two or more individual billets of the same or different composition. As would be apparent to those skilled in the art, the method and device described here may well be employed in a number of applications where an extruded member having a complex transverse structure is desired.

Die 100 is machined from chromium-nickel stainless steel grade 303 but equally other machineable materials with suitable corrosion and heat resistance properties may be used. In the case of extrusion of soft glass material, the inclusion of at least 8% nickel in the steel alloy used to form die 100 will function to prevent sticking of glass material to the die 100 in the extrusion process.

Die 100 includes a die nozzle or collar 120 and a feed hole or sieve plate 130 forming a barrier member between a die inlet chamber 110 and an extrudate forming chamber 150 having an internal wall 123 that terminates in end channel 155 whose diameter is defined by stepped ridge portion 125 thereby forming an end channel 155 whose internal wall 126 is of a greater diameter than extrudate forming chamber 150. End channel 155 allows for an extra degree of freedom in the vertical positioning of feed hold plate 130 within die 100 and therefore the length or height of the extrudate forming chamber 150 for a die collar 120 of fixed height. This is due to the fact that extruded member does not interact with the internal wall 126 of end channel 155 due to its larger diameter when compared to the extrudate forming chamber 150. In this manner, many different combinations of inlet chamber 110 and extrudate chamber 150 heights may be realised for a given die collar size 120 without having to change the extrusion chamber in which the billet and die 100 are mounted during the extrusion process.

The interface between end channel 155 and extrudate forming chamber 150 forms a plane defining the extrudate forming chamber outlet face 151. The terminating edge of end channel 150 also forms a plane defining the die outlet face 152. Die inlet chamber 110 includes circumferential tapered or fluted wall portions 121 which function to force the material to be extruded uniformly towards feed hole or sieve plate 130. Generally, the source material is in the form of a billet having a diameter similar to the diameter of the collar at the inlet plane 122 of the inlet chamber 110.

Feed hole plate 130 is supported by a circumferential stepped recess or shoulder 124 formed in the wall of die collar 120. In this first embodiment, feed hole or sieve plate 130 is forced against shoulder 124 during the extrusion process and may be simply removed from die 120 by pressing feed hole plate 130 in the opposite direction to shoulder 124. Feed hole plate 130 includes a number of regularly spaced feed channels 131 extending through plate 130.

Extending from feed hole plate 130 into extrudate forming chamber 150 and generally in the direction of extrusion are a number of passage forming members 160 which function to form longitudinal passages in the extrudate as material is forced through feed channels 131 and exits feed hole plate outlet face 133 in the extrusion process. In this embodiment, each passage forming member 160 is formed from the exposed shaft portion 142 of pin 140 which further includes a head portion 141 and is located in a corresponding location hole 134 which extends through feed hole plate 130. Exposed shaft portion 142 extends from feed hole plate 130 in the direction of extrusion up to the extrudate forming chamber outlet face 151 ensuring that in this embodiment the resultant passages formed in the extrudate have substantially the same transverse size and shape as the exposed shaft portions 142 of pins 140.

Whilst in this first embodiment, pins 140 are mounted or attached directly to the feed hole plate 130 by insertion into corresponding location holes 134, equally other embodiments whereby passage forming members form part of a separate overlay member having corresponding apertures aligned with feed channels 131 are contemplated to be within the scope of the invention.

Pins 140 are press-fitted into location holes 134 and locate with feed hole plate 130 in the direction of extrusion by virtue of head portion 141. Thus pins 140 may be removed from feed hole plate 130, but as would be appreciated by those skilled in the art, pins 140 may also be integrally formed with feed hole plate 130. By providing for the disassembly of the feed hole plate 130 and individual pins 140, as well as the removal of feed hole plate 130 from die collar 120, each of these components may be cleaned and polished more readily, further improving the preform quality by reducing the roughness of the inner surfaces of the die and thus reducing the surface roughness of the resultant preform.

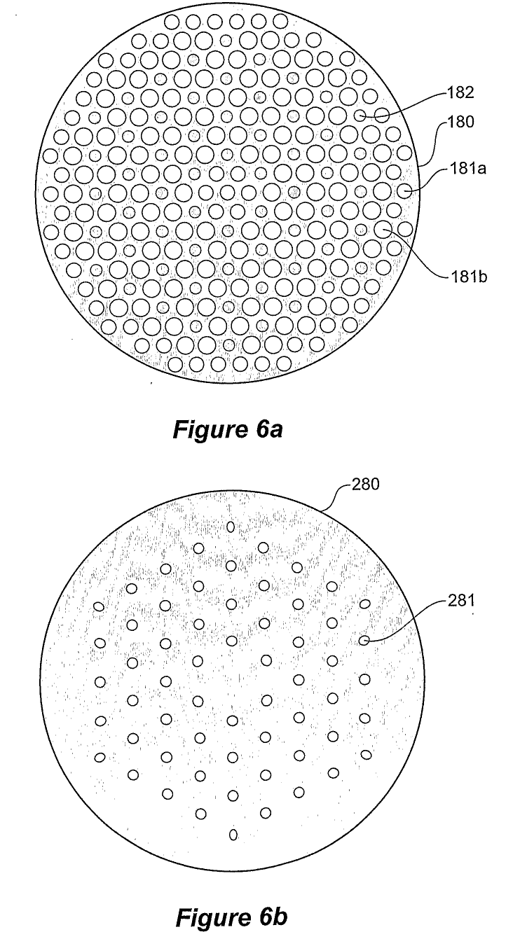

In this feed embodiment, feed channels 131 are all of the same diameter thereby channelling similar amounts of material in the extrusion process. However, these channel diameters may be varied to deliver material at different rates at different locations through feed hole plate 130 as required to allow even and homogeneous flow around the exposed shaft portion 142 of each pin 140 thereby minimising the distortion of the holes or passages in the extruded member (see for example FIGS. 6a and 6b). Additionally, whilst in this first embodiment feed channels 131 are circularly shaped and regular in cross section, equally they may be hexagonal or any other shape and also vary in cross section as required.

Similarly, the exposed shaft portions 142 of pins 140 or more generally passage forming members 160 may be of varying shape and size depending on the desired resultant transverse structure in the extruded member. In addition, the length of passage forming members 160 may be of varying length extending into extrudate forming chamber 150 implying that the free end of individual pins 140 may terminate either above or below extrudate forming chamber outlet face 151 as desired. Furthermore, individual passage forming members 160 may be tapered or more generally change shape or cross section as they extend into the extrudate forming chamber 150 (see for example FIGS. 10 and 12).

In the circumstances, where the orientation of pin 140 with respect to the location on feed hole plate 130 is important, then location grooves and corresponding registration ridges may be incorporated into the side walls of location holes 134 and pins 140 respectively. In another embodiment, location holes 134 and feed channels 131 are of equal diameter and essentially equivalent, thereby providing maximum freedom for location of the pins 140 on the feed hole plate 130 as pins 140 may be located within the lattice of feed channels 131 as desired.

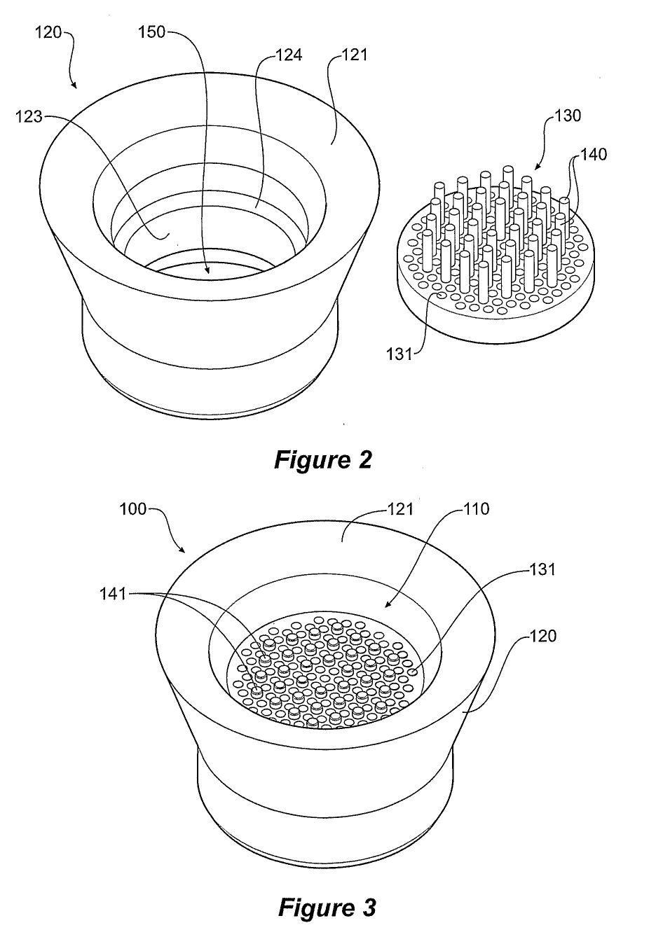

Referring now to FIGS. 2 and 3, there are shown a number of views of die 100 in the unassembled (see FIG. 2) and assembled (see FIG. 3) state. Whilst in this first embodiment, feed hole plate 130 is removable from collar 120, it would be apparent to those skilled in the art that these components may be formed integrally to provide a unitary die. The interspacing of feed channels 131 and pins 140 ensures that the extrudate flows uniformly about each pin 140 thereby forming the walls of the passages that make up the transverse structure of the preform.

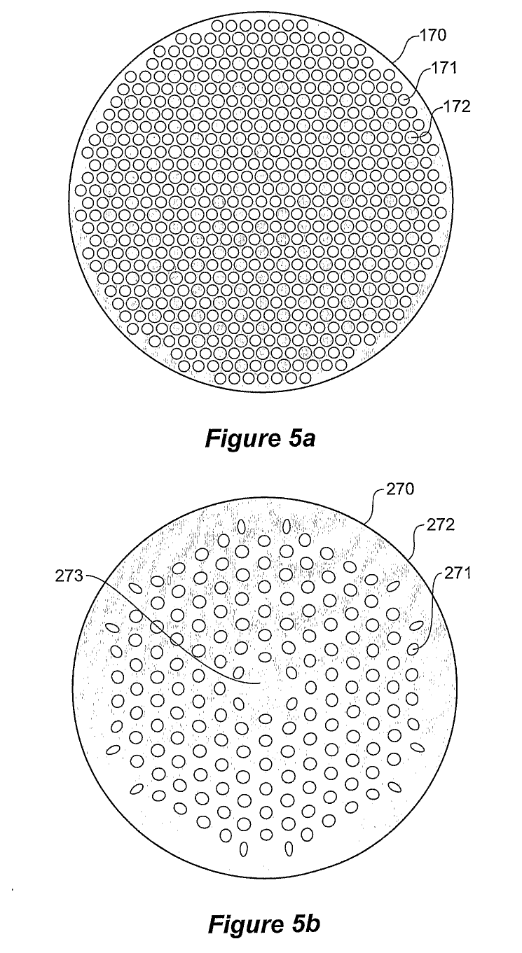

In this embodiment, die 100 incorporates a feed hole plate 130 having a diameter of 18.0 mm, extrudate forming chamber 150 of diameter 15.5 mm, feed channels 131 of diameter 0.8 mm and pins 140 of diameter 1 mm. The distance between each pin 140 is 2 mm and die 100 includes three rings of pins 140 resulting in a total of 36 pins forming a hexagonal lattice structure. An advantage of the present invention is that the die design is easily scalable, for example a feed hole plate 130 having a diameter of 36 mm diameter will allow almost seven rings of pins (i.e. 162 pins), which results in the fabrication of a 30 mm preform having 162 holes each of 1 mm diameter and with an inter-hole or pin spacing of 2 mm (see for example FIGS. 5a and 5b).

Of course other regular or non-regular lattice structures may be formed by suitable arrangement of pins 140 and feed channels 131 with respect to feed hole plate 130. Additionally, where a longitudinal passage corresponding to a cut-out portion is required in the extruded member, say for example to expose an inner region of the extruded member, a passage forming member or combination of passage forming members of appropriate sectional profile corresponding to the shape of the cut-out section may be located towards the edge of the feed hole plate 130.

For fabricating a polymer preform by extrusion using die 100, a billet of cross sectional diameter of 30 mm is introduced at a chamber temperature of 165° C. and fixed ram speed of 0.1 mm/min. The force required to extrude the billet through die 100 at this chamber temperature and ram speed is approximately 4.5 kN corresponding to a resultant pressure on the billet in the region of 6 MPa. For fabricating a preform from lead silicate glass using die 100, the billet chamber temperature required is 520° C. with an associated fixed ram speed of 0.1 mm/min. As such, the force required is approximately 25 kN corresponding to a pressure on the billet of 35 MPa.

The method for forming a preform having a complex transverse structure as described herein may be readily adapted to an extrusion machine which will automate what has hereto been in the prior art a delicate process requiring significant manual input and highly specialised background knowledge. Broadly the extrusion machine incorporates a receptacle for receiving a billet of material and heating means to heat the billet of material to form the extrudable material. The extrudable material is then forced by forcing means as is known in the art through the die which is located in a die receiving chamber which allows the die to be rapidly changed out as required. Finally the extruded member is then received in an output chamber where it is allowed to cool before collection. Clearly, this represents a significant advance over the prior art with the most important advantages of such an extrusion machine being the precise speed and force control via computer control.

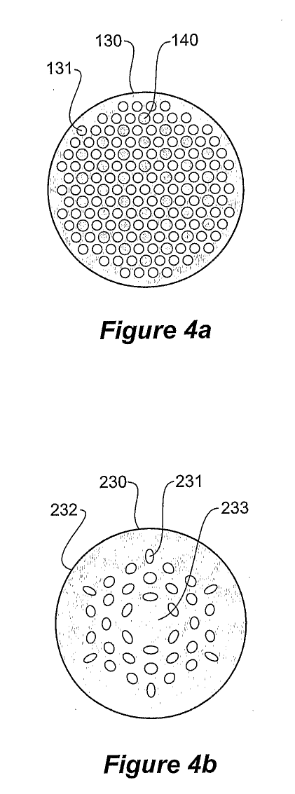

Referring now to FIGS. 4a and 4b there is shown an end view of the three ring pin feed hole plate 130 illustrated in FIGS. 2 and 3 and an end view of the corresponding fibre preform 230 extruded from feed hole plate 130. Fibre preform 230 includes an outer region 232 and an intermediate region consisting of a number of longitudinal channels or passages 231 which extend through the preform 230, these being formed by corresponding pins 140 located in feed hole plate 130 as has been described above thereby defining a core region 233.

Similarly in FIGS. 5a and 5b, corresponding views of a seven ring pin feed hole plate 170 and the corresponding fibre preform 270 are depicted in accordance with a third embodiment of the present invention. This clearly demonstrates the ability to scale the die design and hence the corresponding fibre preform as required. Once again longitudinal channels or passages 271 are formed within an outer region 272 and correspond to the location of pins 172 in feed hole plate 170 which again define a core region 273 in fibre preform 270. The distribution of feed channels 171 ensures that the extruded material flows uniformly about pins 172 to form the passages 271. In this case seven rings are employed as opposed to three as in the previous embodiment.

FIGS. 6a and 6b depict similar views of a four ring pin feed hole plate 180 and fibre preform 280 in accordance with a fourth embodiment of the present invention. In this embodiment, the feed channels are of two different sizes as compared to the feed channels 131, 171 of the three and seven ring designs respectively. In this manner, extruded material will flow more readily through the increased diameter feed channels 181b when compared to the smaller diameter feed channels 181a. In this application, this difference of flow rates has functioned to reduce the distortion and displacement of the longitudinal channels 281 in the fibre preform 280 as formed by pins 182 which may be an important consideration depending on the potential application for the resultant drawn fibre.

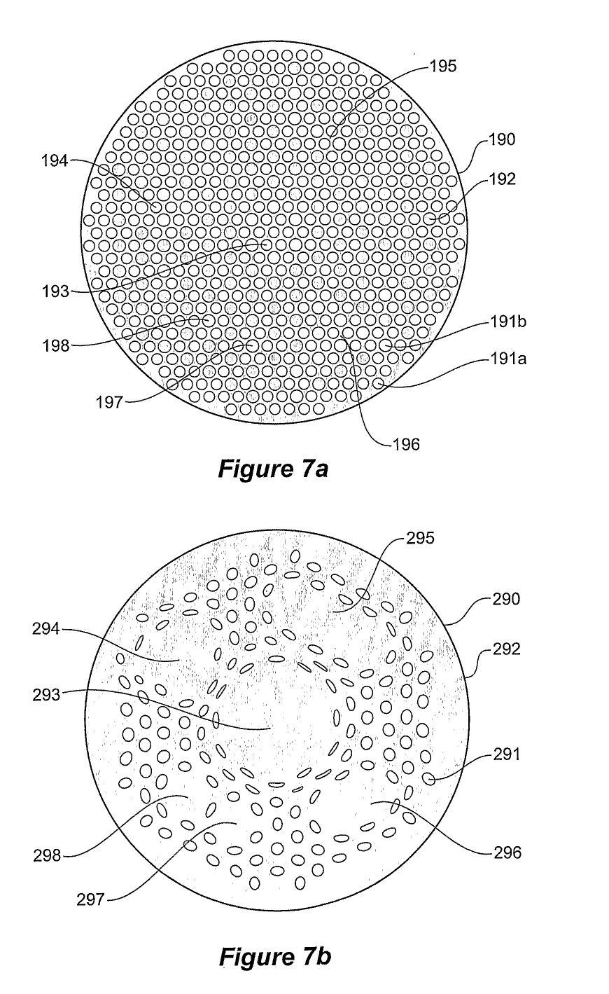

Referring now to FIGS. 7a and 7b, there is shown respective end views of a multi-core feed plate 190 and corresponding fibre preform 290 according to a fifth embodiment of the present invention. In this embodiment, five outer core regions 294, 295, 296, 297, 298 and in inner core region 293 are defined by the arrangement of longitudinal channels 291 which correspond directly to the arrangement of pins 192 which themselves defined corresponding core regions 193, 194, 195, 196, 197, 198 on feed hole plate 190. Once again varying size feed channels 191a, 191b have been employed to modify the flow of the extruded material to compensate for distortions introduced by the extrusion process. As would be appreciated by those skilled in the art, the range of preform designs depicted here clearly demonstrates the use with which the present invention may be adapted to provide extruded members having widely varying complex transverse geometries.

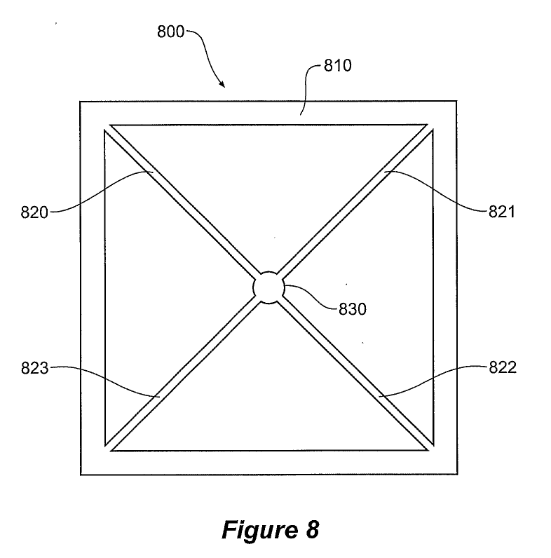

Referring now to FIG. 8, there is shown an end view of a fibre preform 800 having an outer wall 810 and a central longitudinal portion 830 supported by four equally space walls 820, 821, 822, 823. This geometry has applications for the forming of nanowires which are described in detail in co-pending application entitled “Fabrication of Nanowires” claiming priority from Australian Provisional Patent Application No. 2005905619 filed on 12 Oct. 2005, and assigned to the applicant of the present application, and whose contents are incorporated by reference in their entirety herein.

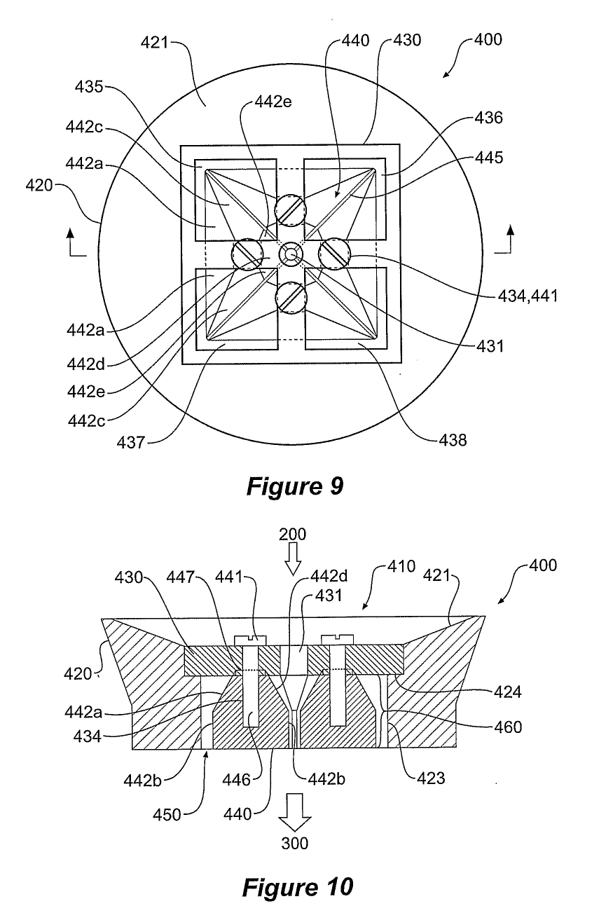

Referring now to FIGS. 9 and 10, there are shown rear and side section views of a die 400 for extruding the fibre preform 800 illustrated in FIG. 8 according to a sixth illustrative embodiment of the present invention. In this sixth illustrative embodiment, the required transverse structure involves forming a central longitudinal portion 830 corresponding to feed channel 431 supported by four equally spaced walls, struts or web members 820, 821, 822, 823 corresponding to the spacing 445 between each of the four pins 440 being fed by material extruding through feed channels 435, 436, 437, 438 located in feed plate 430. Similar to die 100, die 400 includes a collar 420 having fluted or tapered walls 421 and a sieve or feed hole plate 430 that abuts shoulder 424 formed in the wall of collar 420 thereby forming a barrier member between die inlet chamber 410 and extrudate forming chamber 450.

Each pin 440 includes an inner tapered portion 442d, opposed side tapered portions 442c, opposed intermediate tapered portions 442e extending between the inner tapered portion 442d and the opposed side tapered portions 442c and an outer tapered portion 442a. The tapered portions 442a, 442b, 442c, 442d, 442e extend approximately half way down pin 440 and terminate in a vertical walled portion 442b that extends in the direction of extrusion into the extrudate forming chamber 450. The tapered portions 442a, 442b, 442c, 442d, 442e and parallel walled portion 442b act in combination as a passage forming member 460.

Tapered portions 442a, 442b, 442c, 442d, 442e function to guide the extruding material from feed channels 435, 436, 437, 438 to form walls, struts or web portions 820, 821, 822, 823 that support the central longitudinal portion 830 formed from material extruding from feed channel 431. The extrudate chamber walls 423 of collar 420 are arranged in a box or square configuration thereby forming the square profile of outer wall 810 of preform 800. Each pin 440 is attached to the feed plate by a top screw 441 located in location hole 434 which screws into a corresponding threaded aperture 446 extending into pin 440 from a top flattened section 447.

In terms of the dimensions of die 400, feed plate 430 has a length and width of 30 mm with the extrudate forming chamber 450 having a length and width of 26 mm. The arrangement and size of pins 440 results in wall, strut or web portions in the preform of an approximate length of 16 mm and a thickness of 0.5 mm respectively with a core diameter of 2 mm and an outer wall thickness of 1.5 mm.

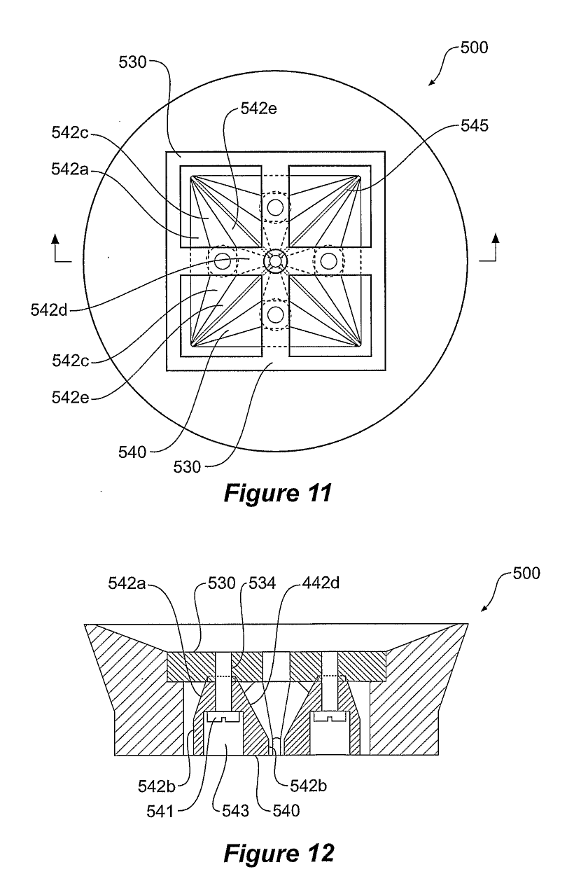

Referring now to FIGS. 11 and 12 there are shown once again rear and side section views of a die 500 for extruding the fibre preform illustrated in FIG. 8 according to a sixth illustrative embodiment of the present invention. In this sixth illustrative embodiment, the geometry of the pins 540 has been modified to further facilitate the flow of extruded material about the pins 540 by changing the degree and extent of tapered portions 542a, 542b, 542c, 542d, 542e with respect to vertical wall portions 542b for each pin 540. Additionally pins 540 are removably attached to feed hole plate 530 by screw 541 which is located in a lower recess 543 of pin 540 and screws upwardly into a threaded receiving aperture 534 located on feed hole plate 530. As would be appreciated by those skilled in the art, the present invention provides the capability to form new fibre preform designs which were not previously capable of being formed using prior art techniques.

Whilst the present invention is described in relation to fabricating a preform for an optical fibre it will be appreciated that the invention will have other applications consistent with the principles described in the specification.

A brief consideration of the above described embodiments will indicate that the invention provides an extremely simple, economical method and device for fabrication of optical fibre preforms that have a large number of transverse features in them, thereby satisfying the growing demand for optical fibres of this type motivated by the growing interest in soft glass photonic bandgap and large mode area fibres.

The nanowires and fibres produced from the preforms that are extruded according to various aspects of the present invention have many applications, including, but not limited to sensors for use in scientific, medical, military/defence and commercial application; displays for electronic products such as computers, Personal Digital Assistants (PDAs), mobile telephones; image displays and sensors for cameras and camera phones; optical data storage; optical communications; optical data processing; traffic lights; engraving; and laser applications.

It will be understood that the term “comprise” and any of its derivatives (e.g. comprises, comprising) as used in this specification is to be taken to be inclusive of features to which it refers, and is not meant to exclude the presence of any additional features unless otherwise stated or implied.

Although a number of embodiments of the device and method of the present invention has been described in the foregoing detailed description, it will be understood that the invention is not limited to the embodiment disclosed, but is capable of numerous rearrangements, modifications and substitutions without departing from the scope of the invention as set forth and defined by the following claims.

1. A die for extruding an extrudable material to form an extruded member, the die comprising:
a barrier member, the barrier member comprising a plurality of feed channels extending through the barrier member;
a passage forming member extending from the barrier member substantially in the direction of extrusion, wherein the feed channels are arranged with respect to the passage forming member to allow the extrudable material to substantially flow about the passage forming member to form a corresponding passage in the extruded member.

2. The die for extruding an extrudable material to form an extruded member as claimed in claim 1, wherein the die comprises a plurality of passage forming members extending from the barrier member substantially in the direction of extrusion and wherein the feed channels are arranged with respect to the plurality of passage forming members to allow the extrudable material to substantially flow about the passage forming members to form corresponding passages in the extruded member.

3. The die for extruding an extrudable material to form an extruded member as claimed in claim 2, wherein at least one of the plurality of passage forming members comprise removable attachment means to removably attach the at least one passage forming member from the barrier means.

4. The die for extruding an extrudable material to form an extruded member as claimed in claim 2, wherein the passage forming members vary in size to form corresponding passages in the extruded member of varying size.

5. The die for extruding an extrudable material to form an extruded member as claimed in claim 1, wherein the feed channels are of varying size to vary the amount of extrusion of said extrudable material.

6. The die for extruding an extrudable material to form an extruded member as claimed in claim 2, wherein the feed channels and the passage forming members are arranged in a regular lattice.

7. The die for extruding an extrudable material to form an extruded member as claimed in claim 1, wherein the die comprises an inlet chamber and an extrudate forming chamber and wherein the barrier member forms a feed hole plate located between the inlet chamber and the extrudate forming chamber.

8. The die for extruding an extrudable material to form an extruded member as claimed in claim 7, wherein the feed hole plate is removable from the die.

9. The die as claimed in claim 1, wherein the extruded member is a microstructured fibre preform.

10. A method for extruding an extrudable material to form an extruded member, the method comprising the steps of:
forcing extrudable material through a plurality of feed channels extending through a barrier member and located about a passage forming member extending from the barrier member in the direction of extrusion; and
forming a passage in the extruded member by allowing the extrudable material to flow about the passage forming member.

11. The method for extruding an extrudable material as claimed in claim 10, wherein the barrier member comprises a plurality of passage forming members extending substantially in the direction of extrusion and wherein the extrudable material is forced through the feed channels to flow about the plurality of passage forming members and form passages in the extruded member corresponding to the plurality of passage forming members.

12. The method for extruding an extrudable material as claimed in claim 11, wherein the passages in the extruded member are formed having different sizes by modifying corresponding passage forming members to have different size, shape or cross section.

13. The method for extruding an extrudable material as claimed in claim 10, wherein the extrudable material is forced through the plurality of feed channels at different flow rates.

14. The method for extruding an extrudable material as claimed in claim 13, wherein the extrudable material is forced through the plurality of feed channels at different flow rates by modifying the plurality of feed channels to have different size, shape or cross section.

15. An extruded member extruded according to the method of claim 10.

16. The extruded member of claim 15, wherein the extruded member is a fibre preform.

17. A fibre drawn from the fibre preform claimed in claim 16.

18. A method for extruding an extrudable material to form an extruded member, the method comprising the steps of:
heating a billet of material in an inlet chamber to a predetermined temperature to form extrudable material;
forcing the extrudable material from the inlet chamber through a barrier member into an extrudate forming chamber, wherein the barrier member comprises a feed hole plate having a plurality of feed channels and at least one passage forming member extending from the feed hole plate in a direction of extrusion, thereby forming at least one corresponding passage in the extruded member.

19. A method for configuring a die, the die for extruding an extrudable material to form an extruded member, the method comprising:
attaching at least one removably attachable passage forming member to a barrier member, the barrier member located between an inlet chamber and an extrudate forming chamber of the die, the barrier member further comprising a plurality of feed channels extending through the barrier member through which in use the extrudable material flows through, wherein a location of the at least one removably attachable passage forming member corresponds to a passage formed in the extruded member.

20. An extrusion machine comprising:
a receptacle for receiving a billet of material;
heating means to heat the billet of material to form an extrudable material;
die receiving chamber to receive a die according to claim 1;
forcing means to force the extrudable material through the die to form an extruded member; and
an output chamber for receiving the extruded member.
